(19) United States
(12) Patent Application Publication
(10) Pub. No.: US 2019/0385364 A1
(43) Pub. Date: Dec. 19, 2019

(54) METHOD AND SYSTEM FOR ASSOCIATING RELEVANT INFORMATION WITH A POINT OF INTEREST ON A VIRTUAL REPRESENTATION OF A PHYSICAL OBJECT CREATED USING DIGITAL INPUT DATA

(71) Applicants: John Joseph, Burlingame, CA (US); Mothusi Hans Colban Pahl, Oakland, CA (US); Teymur Bakhishev, San Jose, CA (US); Jonathan C. Schaffer, Burlingame, CA (US)

(72) Inventors: John Joseph, Burlingame, CA (US); Mothusi Hans Colban Pahl, Oakland, CA (US); Teymur Bakhishev, San Jose, CA (US); Jonathan C. Schaffer, Burlingame, CA (US)

(21) Appl. No.: 16/218,455

(22) Filed: Dec. 12, 2018

Related U.S. Application Data
(60) Provisional application No. 62/597,420, filed on Dec. 12, 2017.

(51) Int. Cl. G06T 17/20; G06F 17/27; G06T 7/50; G06T 7/70

(52) U.S. Cl. CPC G06T 17/20; G06F 17/2785; G06T 2207/10028; G06T 7/70; G06T 2207/20081; G06T 7/50

(57) ABSTRACT

In one embodiment, a computerized method useful for associating relevant information with a point of interest on a virtual representation of a physical object created using digital input data includes receiving at least one sensor input of a physical object. The method uses the at least one set of sensor inputs to create a virtual representation of the physical object. The method determines at least one point of interest on the physical object. The method obtains at least one point of relevant informational input data. The method associates the at least one point of relevant informational input data with at least one point of interest on the physical object.

CLAIM OF PRIORITY AND INCORPORATION BY REFERENCE

This application claims priority from U.S. Provisional Application No. 62597420, title METHODS AND SYSTEMS FOR MONITORING PETROLEUM PRODUCTION AND TRANSPORTATION WITH DRONES and filed 12 Dec. 2017. This application is hereby incorporated by reference in its entirety for all purposes.

### BACKGROUND

### 1. Field

This application relates generally to computer vision, and more specifically to a system, article of manufacture and method of associating relevant information with a point of interest on a virtual representation of a physical object created using digital input data.

### 2. Related Art

Companies spend great resources to manually inspect infrastructure. For example, pipelines can run for hundreds of miles. Manual inspection of hundreds of miles of infrastructure can involve costly travel and time of teams of inspectors travelling the length of the pipeline. At the same time, robots are now able to travel to obtain sensor data from remote locations. This information can be communicated to teams of inspectors without the need to travel and be physically present at the inspection site. However, improvements to computer vision are needed to improve the remote inspection and monitoring processes.

### BRIEF SUMMARY OF THE INVENTION

In one embodiment, a computerized method useful for associating relevant information with a point of interest on a virtual representation of a physical object created using digital input data includes receiving at least one sensor input related to the physical object. The method the at least one set of sensor inputs to create a virtual representation of the physical object. The method determines at least one point of interest on the physical object. The method obtains at least one point of relevant informational input data. The method associates the at least one point of relevant informational input data with at least one point of interest on the physical object.

### BRIEF DESCRIPTION OF THE DRAWINGS

FIG. 1 illustrates an example system for monitoring petroleum production and transportation with drones, according to some embodiments.

FIG. 2 depicts an exemplary computing system that can be configured to perform any one of the processes provided herein.

FIG. 3 is a block diagram of a sample computing environment that can be utilized to implement various embodiments.

FIG. 4 illustrates an example process for implementing a drone inspection of a pipeline segment, according to some embodiments.

FIG. 5 illustrates an example process for implementing a drone inspection of a specified petroleum facility, according to some embodiments.

FIG. 6 illustrates an example process to train a vision module to identify industrial objects, according to some embodiments.

FIG. 7 illustrates an example process for implementing automated industrial site labeling, according to some embodiments.

FIGS. 8 A-C illustrate another example process of training a vision module to identify industrial objects, according to some embodiments.

The Figures described above are a representative set, and are not an exhaustive with respect to embodying the invention.

### DESCRIPTION

Disclosed are a system, method, and article of method and system of associating relevant information with a point of interest on a virtual representation of a physical object created using digital input data. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Definitions

Example definitions for some embodiments are now provided.

Application programming interface (API) can specify how software components of various systems interact with each other.

Augmented reality (AR) is a live direct or indirect view of a physical, real-world environment whose elements are augmented by computer-generated or extracted real-world sensory input such as sound, video, graphics or GPS data.

Autonomous underwater vehicle (AUV) can be a robot that travels underwater without requiring input from an operator.

Computer-aided design (CAD) is the use of computer systems (or workstations) to aid in the creation, modification, analysis, or optimization of a design.

Cloud computing can involve deploying groups of remote servers and/or software networks that allow centralized data storage and online access to computer services or resources. These groups of remote serves and/or software networks can be a collection of remote computing services.

Computer vision (CV) is an interdisciplinary field that deals with how computers can be made for gaining high-level understanding from digital images or videos. Computer vision tasks include methods for acquiring, processing, analyzing and understanding digital images, and extraction of high-dimensional data from the real world in order to produce numerical or symbolic information.

Convolutional neural network (CNN) is a class of deep neural networks, most commonly applied to analyzing visual imagery. CNNs use a variation of multilayer perceptrons designed to require minimal preprocessing. They are also known as shift invariant or space invariant artificial neural networks (SIANN), based on their shared-weights architecture and translation invariance characteristics.

Lidar is a surveying method that measures distance to a target by illuminating the target with pulsed laser light and measuring the reflected pulses with a sensor. Differences in laser return times and wavelengths can then be used to make digital 3-D representations of the target.

Pigging refers to the practice of using devices known as “pigs” to perform various maintenance operations. This is done without stopping the flow of the product in the pipeline.

Photogrammetry is the science of making measurements from photographs, especially for recovering the exact positions of surface points.

Point cloud can be a set of data points in space.

Unmanned aerial vehicle (UAV), commonly known as a drone, is an aircraft without a human pilot aboard. UAVs are a component of an unmanned aircraft system (UAS); which include a UAV, a ground-based controller, and a system of communications between the two. The flight of UAVs may operate with various degrees of autonomy: either under remote control by a human operator or autonomously by an onboard computer.

Unmanned ground vehicle (UGV) can be a vehicle that operates while in contact with the ground and without an onboard human presence.

Unmanned surface vehicles (USV) can be a vehicle that operates on the surface of the water (watercraft) without a crew.

Virtual reality (VR) is a computer technology that uses Virtual reality headsets, sometimes in combination with physical spaces or multi-projected environments, to generate realistic images, sounds and other sensations that simulate a user's physical presence in a virtual or imaginary environment. A person using virtual reality equipment is able to “look around” the artificial world, and with high quality VR move about in it and interact with virtual features or items. VR headsets are head-mounted goggles with a screen in front of the eyes. Programs may include audio and sounds through speakers or headphones.

Exemplary Systems

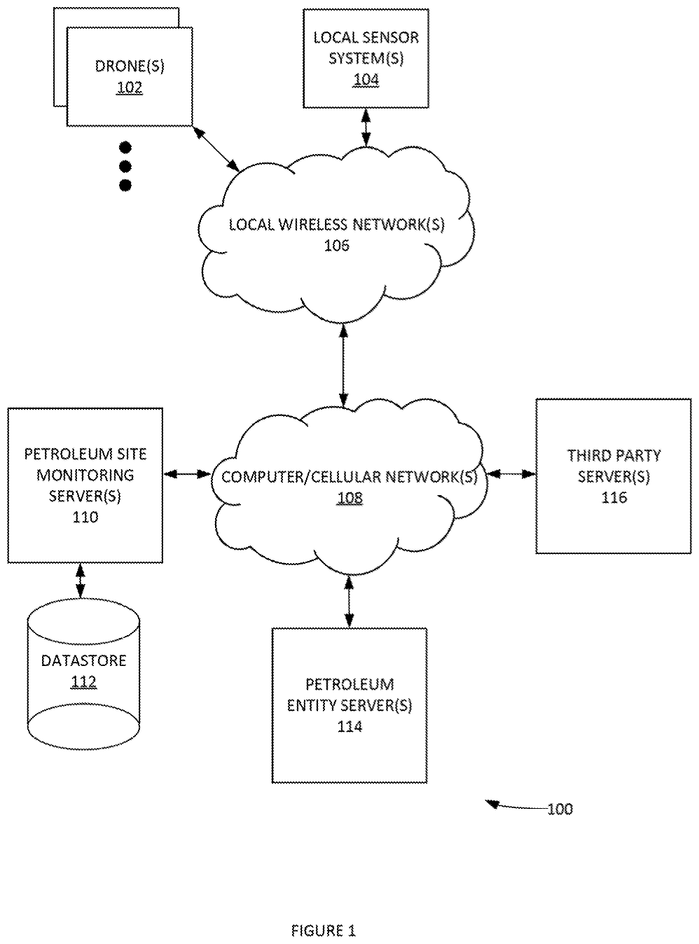

FIG. 1 illustrates an example system 100 for monitoring petroleum production and transportation with drones, according to some embodiments. Drones 102 can be unmanned autonomous vehicles. Example drone system can include, inter alia: UAV, UGV, USV, AUV, etc. Drones 102 can include various sensors. Sensors can include, inter alia: digital cameras, chemical sensors, IR/UV cameras (and/or other heat sensors), motion sensors, audio and/or various sound sensors (e.g. one or more microphones, etc.), and the like. Drones 102 can communicate sensor data to petroleum site monitoring servers 110. Drones 102 can be programmed to travel (e.g. fly) in a specified pattern around a particular petroleum facility and/or pipelines. These patterns can be designed to optimize drone power usage, drone memory/data storage usage, drone processing power, and the like. Drones 102 can be docked with local docking systems for powering, data transmission, software updates, and/or other operations. Drones 102 can interface with local sensors systems 104. Drones 102 can periodically patrol a petroleum facility and/or pipeline segment based on various conditions. For example, UAV can fly a specified pattern around a petroleum extraction facility on a periodic basis and/or based on certain triggers related to local sensor system 104 data. For example, a local sensor system 104 can detect an increase in heat in a particular region of a petroleum facility (e.g. indicating a fire, etc.). This information can be communicated to drone 102 while in a docking bay. Drone 102 can then fly to the particular region of a petroleum facility and obtain specified additional sensor data in real time (e.g. assuming networking and/or processing latencies). Example additional sensor data can include, inter alia: a digital video, a chemical sensor reading (e.g. to determine a chemical leak), additional heat readings, etc. Drones 102 can also include equipment for responding to a particular issue. For example, in the case of a fire, drones 102 can include anti-fire equipment such as fire extinguishers, etc. UAVs can be a tricopter, a quadcopter, a hexacopter, an octocopter, etc.

It is noted that in some examples, drones 102 can include a combination of UAV, UGV, USV, AUV, etc. For example, one or more UAVs can be transported by a single UGV. Upon detecting a trigger event (e.g. reaching a specified location, local sensor data values, etc.), the one or UAVs can be activated and fly a specified route to obtain data from UAV sensors. For example, UGV can reach particular location of a pipeline. A set of UAVs transported by the UGV can then fly a specified portion of the pipeline to obtain a digital video/images of specified portions of said pipeline. UGV can also include sensors to obtain data of the specified portion of the pipeline as well.

In another example, an AUV or UGV can be used to deliver one or more ‘pig’ drone. A pig drone can be used to into a pipeline to obtain various specified sensor data (e.g. a three-hundred and sixty-degree video of an interior portion of the pipeline, chemical sensor data, flow rate data, etc.).

Local sensor systems 104 can local sensors that monitor various aspects of a particular petroleum facility and/or pipelines. Local sensors 104 can include, inter alia: digital cameras, chemical sensors, IR/UV cameras (and/or other heat sensors), motion sensors, audio and/or various sound sensors. Local sensors systems 104 can also include, inter alia: pressure sensors, flow rate sensors, etc. Local sensors systems 104 can include wireless/computer networking systems (e.g. Wi-Fi, Internet, cellular phone systems, satellite phone systems, etc.). In this way, local sensors systems 104 can communicate sensor data to drones 102, petroleum site monitoring servers 110, etc.

Petroleum site monitoring servers 110 can receive data from drones 102 and/or local sensors systems 104. Petroleum site monitoring servers 110 can manage the actions of drones 102. For example, Petroleum site monitoring servers 110 can direct drones 102 to move to specified locations and obtain specified sensor data. Petroleum site monitoring servers 110 can include functionalities for determining optimal travel patterns (e.g. optimal flight patterns, etc.) for drones to obtain requested sensor data. Optimization can be in terms of maximizing drone power, maximizing sensor data accuracy, drone safety, drone memory and/or processing, any combination of these, etc.

Petroleum site monitoring servers 110 can convert incoming sensor data to virtual reality models. Virtual reality models can include pre-generated models of a particular petroleum facility and/or pipeline and/or additional events based on sensor data (e.g. images of a pipeline leak, icons, images of a fire, images of a broken machine, etc.). Petroleum site monitoring servers 110 can convert incoming sensor data to augmented reality models. Augmented reality models can include pre-generated models of a particular petroleum facility and/or pipeline and/or additional events based on sensor data (e.g. images of a pipeline leak, icons, images of a fire, images of a broken machine, etc.).

Petroleum site monitoring servers 110 can provide a dashboard. An administrator can use the dashboard to manage drone 102 asset. For example, the administrator can program drone travel patterns and/or times and/or triggers. Administrator can specify uses of drone 102 and/or local sensor 104 data.

Petroleum site monitoring servers 110 can obtain models of petroleum facilities and/or pipelines. These can be three-dimensional (3D) models obtained from the entities that operate/manage/own the petroleum facilities and/or pipelines. Petroleum site monitoring servers 110 can use two-dimension (2D) video feeds and/or sensor data (e.g. from drones 102 and/or local sensors 104, etc.) to augment the 3D models. These augmented 3D models can be displayed in a 3D virtual video and/or 3D augmented reality video. The augmented 3D models can be updated in real time based on incoming data streams from the site. The augmented 3D models can be communicated to other entities (e.g. proprietary petroleum facility and/or pipeline entities, regulatory entities, emergency response entities, etc.). For example, emergency responders to an oil spill of a pipeline can view a video feed from a UAV digital camera overlaid on an augmented 3D model of the pipeline. In this way, emergency responders can be plan response strategies based on real-time information before the oil spill is viewable by arriving emergency responders. Accordingly, petroleum site monitoring servers 110 can include various computer graphics generation functionalities that can a digital image data from 3D models and/or vice versa (e.g. see infra).

Petroleum site monitoring servers 110 can implement can include computer vision functionalities. Petroleum site monitoring servers 110 can include object recognition systems. Petroleum site monitoring servers 110 can include libraries of various petroleum systems and corresponding identification elements (e.g. graphics, icons, designs, schematics, etc.) to be used by object recognition systems. These object recognition systems can also identify non-petroleum device/systems that are relevant. For example, object recognition systems can recognize third-party construction near a pipeline, forest fires, flooding, third-party vehicles, roads, geographic landmarks and/or various threats to a petroleum facility and/or pipeline. Petroleum site monitoring servers 110 can produce 3D models from digital image data obtain by drones 102 and/or local sensors 104. Accordingly, petroleum site monitoring servers 110 can include, inter alia: image processing and image analysis systems; 3D analysis from 2D images systems; machine vision systems; imaging systems; pattern recognition systems; etc. In this way, petroleum site monitoring servers 110 can perform remote automatic inspection analysis of a petroleum facility and/or pipeline and/or areas/environs around the petroleum facility and/or pipeline. Petroleum site monitoring servers 110 can use information from drones 102 and/or local sensors 104 to assist humans in identification tasks; implement controlling processes (e.g. turn off/regulate flow in a pipeline, etc.); detecting events (e.g., for visual surveillance, etc.); model objects or environments (e.g., petroleum device/system image analysis, pipeline image analysis, topographical modeling, etc.); navigation operations (e.g. guiding a drone, developing a drone flight/driving plane, etc.), organizing information (e.g., for indexing databases of images and image sequences); photogrammetry; etc.

Petroleum site monitoring servers 110 can detect/monitor changes in a pipeline over time. Petroleum site monitoring servers 110 can detect/monitor emergency conditions (e.g. a pipeline leak, imminent pipeline leak, etc.) in a pipeline. Petroleum site monitoring servers 110 can take initial steps to prevent and/or ameliorate a pipeline leak and/or an imminent pipeline leak. Machine learning and/or other artificial intelligence systems can be used to determine if a particular pipeline condition represents a pipeline leak and/or imminent pipeline leak (e.g. based on a set of historical data of past pipeline leaks and/or imminent pipeline leaks, etc.). These techniques can be applied to other petroleum facility situations, petroleum shipping entities (e.g. ships, trucks, rail road containers, etc.), petroleum storage containers, and the like.

Petroleum site monitoring servers 110 can include various other functionalities and systems, including, inter alia: email servers, text messaging servers, instant messaging servers, video-sharing servers, mapping and geolocation servers, network security services, language translation functionalities, database management systems, application programming interfaces, etc. Petroleum site monitoring servers 110 can include various machine learning functionalities that can analyze sensor data, emergency response actions, petroleum company profiles, etc.

Petroleum site monitoring servers 110 can utilize machine learning techniques (e.g. artificial neural networks, etc.). Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Local wireless networks 106 can include inter alia: Wi-Fi networks, LPWAN, BLE®, etc. Low-Power Wide-Area Network (LPWAN) and/or Low-Power Network (LPN) is a type of wireless telecommunication wide area network designed to allow long range communications at a low bit rate among things (connected objects), such as sensors operated on a battery. The low power, low bit rate and intended use distinguish this type of network from a wireless WAN that is designed to connect users or businesses, and carry more data, using more power. LoRa can be a chirp spread spectrum (CSS) radio modulation technology for LPWAN. It is noted that various other LPWAN networks can be utilized in various embodiments in lieu of a LoRa network and/or system. BLUETOOTH® Low Energy (BLE) can be a wireless personal area network technology. BLE can increase in data broadcasting capacity of a device by increasing the advertising data length of low energy BLUETOOTH® transmissions. A mesh specification can enables using BLE for many-to-many device communications for home automation, sensor networks and other applications.

Computer/Cellular networks 108 can include the Internet, text messaging networks (e.g. short messaging service (SMS) networks, multimedia messaging service (MMS) networks, proprietary messaging networks, instant messaging service networks, email systems, etc. Computer/Cellular networks 108 can include cellular networks, satellite networks, etc. Computer/Cellular networks 108 can be used to communicate messages and/or other information (e.g. videos, tests, articles, other educational materials, etc.) from the various entities of system 100.

Petroleum entity servers 114 can include the owners/managers of petroleum facility and/or pipelines. Petroleum entity servers 114 can provide petroleum site monitoring servers 110 with information about petroleum facility and/or pipelines (e.g. GPS/location data, petroleum device identifier data, pipeline content data, pipeline flow data, emergency data, schematic data, etc.). Third-party servers 116 can include various entities that provide third-party services such as, inter alia: weather service entities, GPS systems, mapping services, drone repair/recovery services, geological data services, etc.). Third-party servers 116 can various governmental regulatory agency servers (e.g. for reporting potential violations of applicable governmental rules, for obtaining applicable governmental rules, etc.). It is noted that, in some embodiments, various functionalities implemented by can petroleum site monitoring servers 110 can be implemented in on-board drone computing systems and/or in specialized third-party servers 116 (e.g. computer vision systems, navigation systems, etc.).

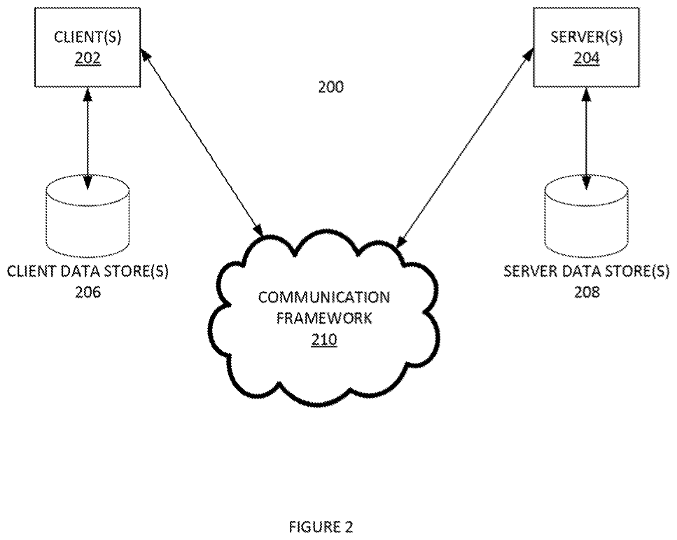

FIG. 2 depicts an exemplary computing system 200 that can be configured to perform any one of the processes provided herein. In this context, computing system 200 may include, for example, a processor, memory, storage, and I/O devices (e.g., monitor, keyboard, disk drive, Internet connection, etc.). However, computing system 200 may include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein. The main system 202 includes a motherboard 204 having an I/O section 206, one or more central processing units (CPU) 208, and a memory section 210, which may have a flash memory card 212 related to it. The I/O section 206 can be connected to a display 214, a keyboard and/or other user input (not shown), a disk storage unit 216, and a media drive unit 218. The media drive unit 218 can read/write a computer-readable medium 220, which can contain programs 222 and/or data. Computing system 200 can include a web browser. Moreover, it is noted that computing system 200 can be configured to include additional systems in order to fulfill various functionalities. Computing system 200 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

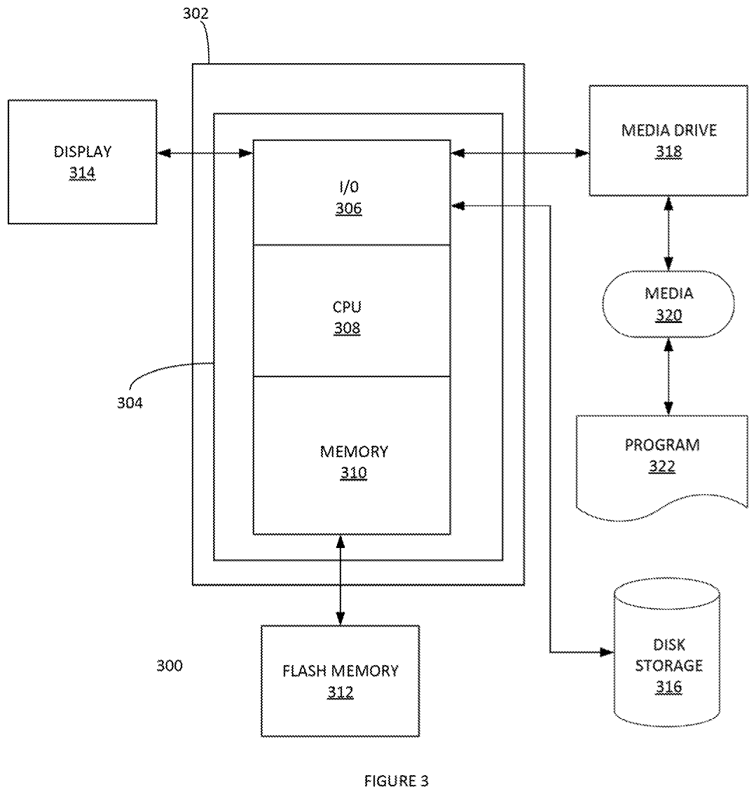

FIG. 3 is a block diagram of a sample computing environment 300 that can be utilized to implement various embodiments. The system 300 further illustrates a system that includes one or more client(s) 302. The client(s) 302 can be hardware and/or software (e.g., threads, processes, computing devices). The system 300 also includes one or more server(s) 304. The server(s) 304 can also be hardware and/or software (e.g., threads, processes, computing devices). One possible communication between a client 302 and a server 304 may be in the form of a data packet adapted to be transmitted between two or more computer processes. The system 300 includes a communication framework 310 that can be employed to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304. In some embodiments, system 300 can instead be a collection of remote computing services constituting a cloud-computing platform.

Exemplary Methods

The following methods/processes can be implemented by systems 100-300.

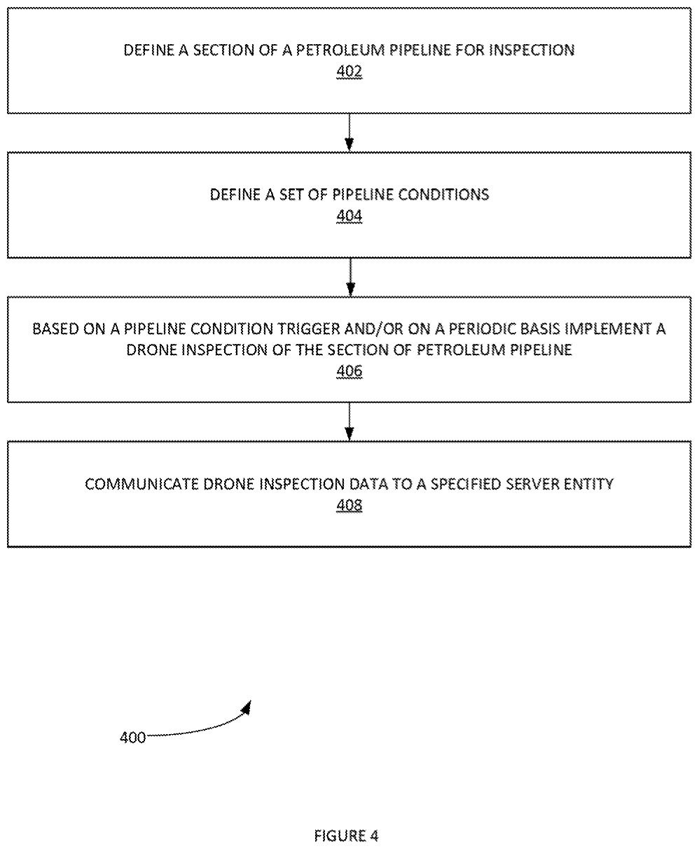

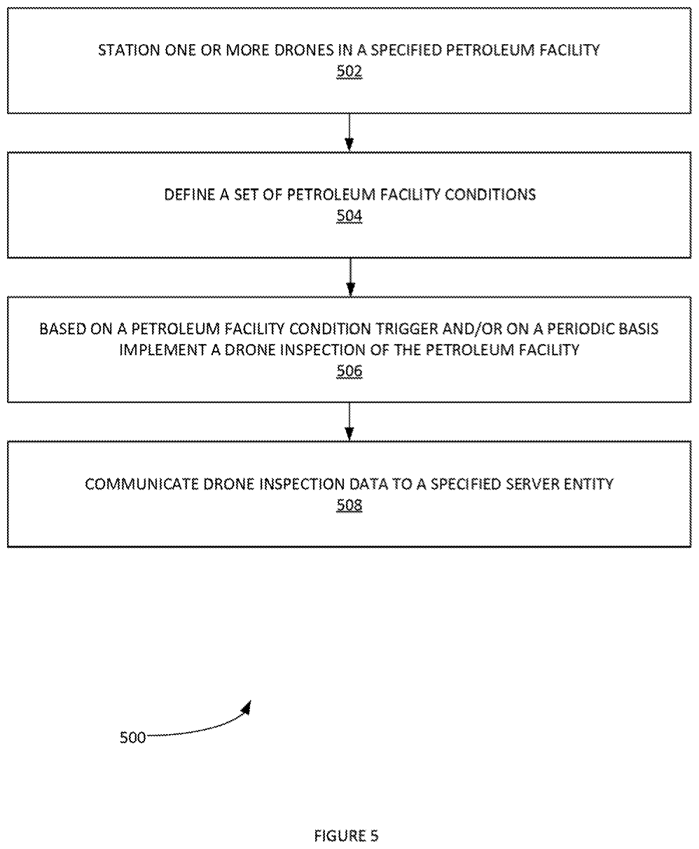

FIG. 4 illustrates an example process 400 for implementing a drone inspection of a pipeline segment, according to some embodiments. In step 402, process 400 can define a section of a petroleum pipeline for inspection. In step 404, process 400 can define a set of pipeline conditions. Example conditions can include, inter alia: rust/corrosion, fugitive emissions, nearby building or road construction site encroachment, other changes in the state of the pipeline, over time, etc. In step 406, process 400 can, based on a pipeline condition trigger and/or on a periodic basis, implement a drone inspection of the section of petroleum pipeline. Drones can be a combination of ground and air drones. Drones can obtain digital video/images of the section of a petroleum pipeline. Drones can obtain air/surface chemicals from pipeline and/or nearby ground surface for analysis with on-board chemical sensors. Drones can obtain a heat profile of portions of the pipeline. In step 408, process 400 can communicate drone inspection data to a specified server entity (e.g. petroleum site monitoring servers 110, governmental agency, pipeline owner, local law enforcement, etc.).

In one example, an automated real-time system of sensor data collection can be implemented. Automated agents (e.g. drones, UGVs, USVs, Pigs, etc.) can be used to collect information about a specific site and feed that sensor data into a monitoring system. The monitoring system can then use the algorithmically generated 3D models, CV object detection models and/or NLP context detection models as a basis for its analysis and resulting actions. This can include operations such as, inter alia: detection of anomalous event indicators that trigger automated and/or manned responses to such events.

FIG. 5 illustrates an example process 500 for implementing a drone inspection of a specified petroleum facility, according to some embodiments. In step 502, process 500 can station one or more drones in a specified petroleum facility (and/or device and/or system). In step 504, process 500 can define a set of petroleum facility conditions. In step 506, process 500 can based on a petroleum facility condition trigger and/or on a periodic basis implement a drone inspection of the petroleum facility. Drones can be a combination of ground and air drones. Drones can obtain digital video/images of the section of a petroleum facility. Drones can obtain air/surface chemicals from petroleum facility and/or nearby ground surface for analysis with on-board chemical sensors. Drones can obtain a heat profile of portions of the petroleum facility. In step 508, process 500 can communicate drone inspection data to a specified server entity.

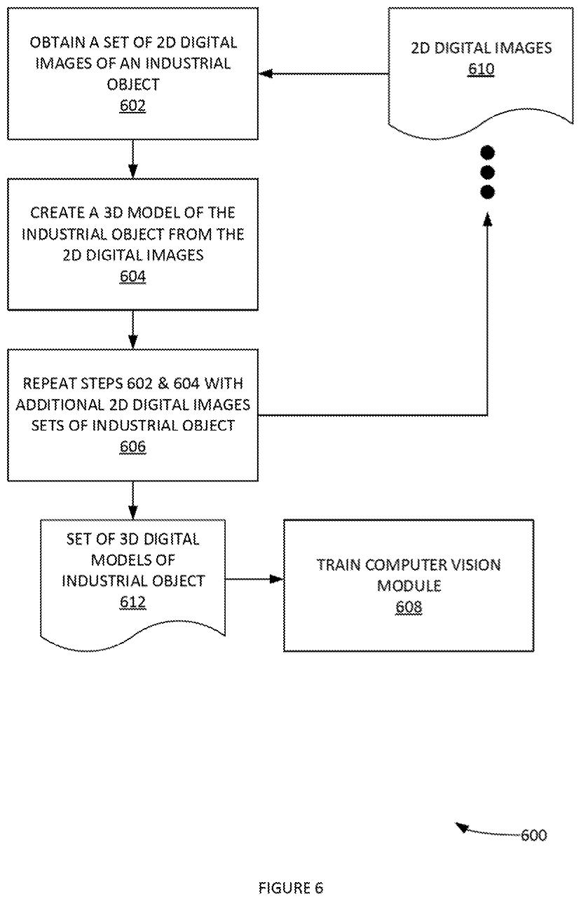

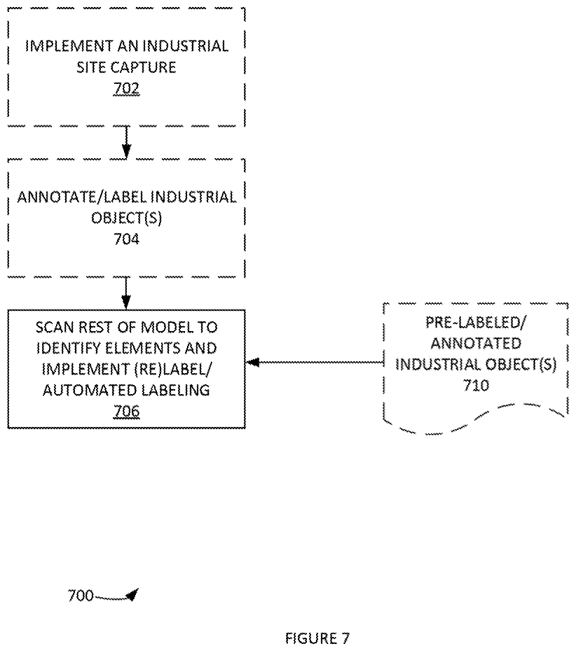

FIG. 6 illustrates an example process 600 to train a vision module to identify industrial objects, according to some embodiments. Process 600 can use computer vision to identify industrial objects. Process 600 can use the photo set to train a computer vision module. Process 600 can train a 3D vision module to understand shapes in 3D models that come from either Photogrammetry created models, primitives, CAD drawings, pre-existing 3D models.

In step 602, process 600 can obtain a set of 2D digital images 610 of an industrial object. 2D digital images 610 can be obtained from various sources. For example, 2D digital images 610 can be obtained from digital cameras in drones that have and/or are currently inspecting an industrial object. 2D digital images 610 can be obtained from manufactures and/or users of industrial objects. 2D digital images 610 can be obtained from Internet searches. 2D digital images c610 can be obtained from other third-party sources/databases.

In step 604, process 600 can create a 3D model of the industrial object from the 2D digital images. For example, step 604 can create a 3D model using photogrammetry methods. In step 606, process 600 can repeat steps 602 and 604 with additional 2D digital images sets 610 of industrial object. In step 608, process 600 can use the set of 3D models 612 to train a vision module to identify industrial objects. Step 600 can be implemented in real-time (e.g. assuming networking and processing latencies) for a drone inspecting an industrial object(s).

In one example, process 600 can be used to train a computer vision module to recognize a pump jack. Process 600 can use probability methods as well (e.g. a probabilistic labelling scheme, etc.). For example, process 600 can identify a 3D model of pump jack because of a specified percentage of 2D images used to generate the 3D model were of pump jacks. Process 600 can use that 3D model (as well as additional number of other 3D models probabilistic identified as ‘pump jack’) to train a 3D vision module that reviews as set of point clouds from 3D modules of 2D photos. For example, a thousand sets of 2D images of which a specified percentage are identified (e.g. by a curator, a computer vision system, etc.) can be used to generate a single 3D model. In this way, a thousand 3D models can be generated and used to train a pump jack model. Some or all 3D models can also be labeled by a curator to increase accu racy.

In one example, stereophotogrammetry can be used to generate 3D models. Process 600 can use stereophotogrammetry to estimate the three-dimensional coordinates of points on an industrial object employing measurements made in two or more photographic images taken from different positions (e.g. using stereoscopy, etc.). Common points can be identified on each image. A line of sight (or ray) can be constructed from the camera location to the point on the object. The intersection of these rays (triangulation) can be used to determine the 3D location of the point. Various algorithms can exploit other information about the scene (e.g. can be known a priori) for example symmetries, in some cases allowing reconstructions of 3D coordinates from only one camera position. Stereophotogrammetry can be used in combination with other non-contacting measurement techniques to determine dynamic characteristics and mode shapes of non-rotating and rotating structures. Process 600 can utilize stereophotogrammetry to combine live action with computer-generated imagery. somewhat similar application is the scanning of objects to automatically make 3D models of them. Process 600 can use various programs such as, inter alia: 3DF Zephyr, RealityCapture, Acute3D's Smart3DCapture, ContextCapture, Pix4Dmapper, Photoscan, 123D Catch, Bundler toolkit, PIXDIM, and Photosketch, etc. to generate 3D models using photogrammetry. It is noted that some 3D model can include gaps, accordingly, various software systems such as MeshLab, netfabb or MeshMixer can be implemented to improve the 3D model.

Process 600 can be used to generate a database of 3D models of industrial objects. This database can then be used for later 3D object recognition. A 3D computer vision module can examine any point cloud for a known 3D model. Process 600 can create a 3D data set with 2D data set that are saved from historical digital images obtained from drone inspections. Process 600 can also, in some embodiments, utilize/integrate CAD drawings of industrial objects into a 3D model. Process 600 can also harvest existing data sets imported from web searches, free databases, etc. to pull in existing 3D models as well. Process 600 can incorporate data from sonar systems, LIDAR systems, etc. For example, use camera and sonar hybrid to create a 3D model and then put that through 3D vision module. In one example, a 3D scanning system can create a portion of 3D model by scanning a portion of the industrial object.

Process 600 can train a 3D vision module with other 3D modules to recognize in a point cloud. Process 600 can implement various 2D digital image editing techniques (e.g. filter out sharp shadows, etc.). Process can utilize various graphics editing systems (e.g. raster graphics editors, etc.).

It is noted that process 600 can also be reversed in order to generate a set of 2D digital images from a 3D model (e.g. by taking exports of 3D at different angles, etc.).

Process 600 can implement a photogrammetry reconstruction process and, at intervals, stop it and determine if enough information is available to interpret the identity of the industrial object before process finished. For example, if there is a million-polygon processing limit, process 600 can avoid wasting processing bandwidth on portion that is already known and/or have a high probability of knowing. These portions can be replaced with generic models. Additionally, machine learning can be used to determine high probability that a portion of the 2D digital image and/or 3D model is a cube and use processing quota on other aspects of image. In this way, process 600 can use short cuts for primitives to speed up reconstruction of other aspects of the 3D model. Process 600 can use a partial point cloud and partial reconstruction and once determine then replace with something known (e.g. a portion of a 3D model that already have).

Additional methods that can be integrated into process 600 are now discussed. In one example, process 600 can implement a high polygon rendering of an area of a 3D model. Process 600 can then implement a low polygon rendering (e.g. a decimated version) of another area and cut out portions to replace with extant models (e.g. tanks, bulldozers, etc.) that have been determined to be in the other area. Process 600 can be manual and/or be automated with machine learning techniques. For example, process 600 may know a priori what type of pump jacks a company uses and feed relevant CAD drawings into the training set when dealing with that particular customer.

In one example, can use a quadratic equation to render portions of a 3D model. With a quadratic equation, given a diameter and length of cylinder, process 600 then use bending portion as a 3D mesh of polygons. Instead of a mesh, process 600 can render the parametric cylinder equation into the 3D model. The rendering can be a hybrid of primitives and the quadratic equations.

Example machine learning techniques can include Supervised Learning (e.g. Regression, Decision Tree, Random Forest, KNN, Logistic Regression etc.); Unsupervised Learning (e.g. Apriori algorithm, K-means); Reinforcement Learning (e.g. Markov Decision Process). Other techniques can include Linear Regression Logistic Regression Decision Tree SVM Naive Bayes KNN K-Means Random Forest Dimensionality Reduction Algorithms Gradient Boosting algorithms GBM XGBoost LightGBM CatBoost, etc.

FIG. 7 illustrates an example process 700 for implementing automated industrial site labeling, according to some embodiments. In step 702, process 700 can implement an industrial site capture. In step 704, process 700 can label/annotate the various industrial objects in said site. These industrial objects can be identified using process 600 supra. Optionally, in step 702, process 700 can receive a labeled/annotated capture dataset 708. Labeled/annotated capture dataset 708 can be curated. For example, process 700 can select a point of interest on a pipeline and associate it with a specific dataset (e.g. type, other info, sensor data, etc.). In step 708, process 700 can scan a 3D model of the site (e.g. generate by process 600 from, in part, drone digital video) to identify elements and (re)label/annotate industrial objects. Data overlays on the 3D model can be based on 3D model data, sensor data, company descriptions, regulatory data, etc. Process 600 can use this data to automatically label points of interest (e.g. based on a specified probability value). Automated labels can be manually reviewed and updated. Process 600 can include text recognition functionalities to so identify numbers/text on industrial objects to aid in identification of said industrial objects.

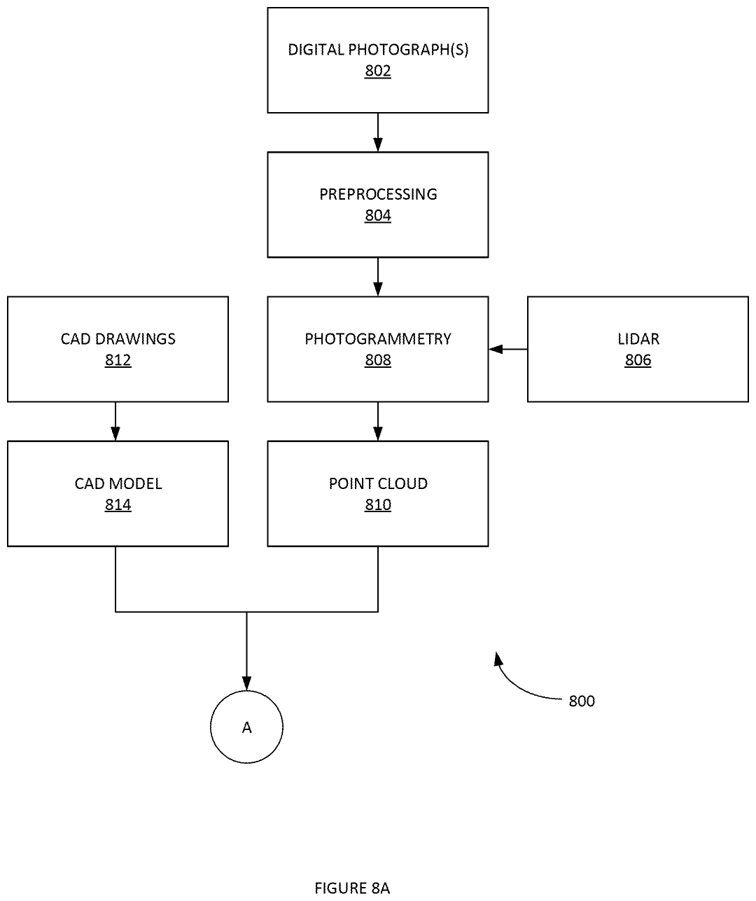

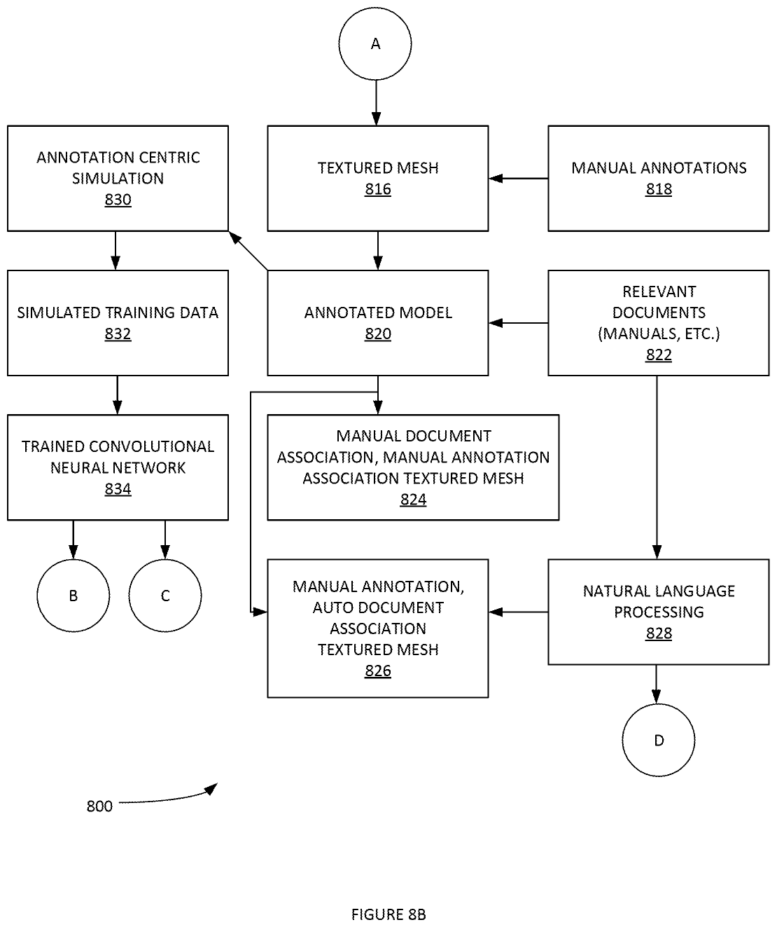

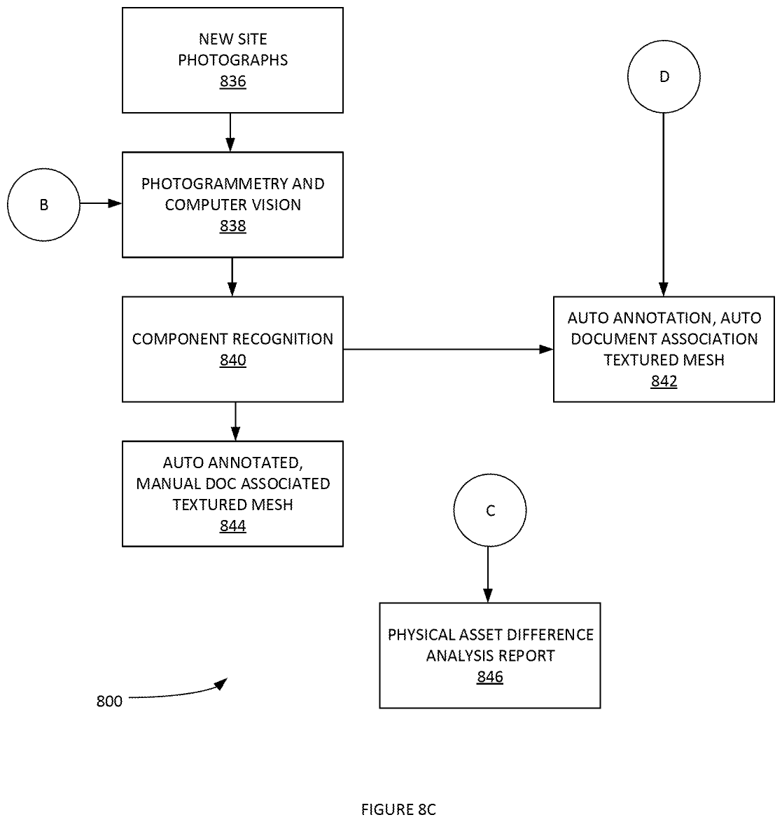

FIGS. 8A-C illustrate another example process 800 of training a vision module to identify industrial objects, according to some embodiments. Process 800 can taken sensor inputs related to an object (e.g. digital photographs, CAD input, LIDAR input). Process 800 can use photogrammetric processes to generate a point cloud. The point cloud can be used to produce a textured mesh of the object. The textured mesh can then be annotated and viewed. This can be used as the basis for generating a Computer Vision (CV) model training and test sets generated through simulation (e.g. capturing 2D images of the 3D object n a virtual environment from different positions under different lighting and environmental conditions). Once the training and test sets are generated, process 800 can train and use the CV on future/later textured meshes to recognize whole objects, as well as, sub-systems and individual components. The object detection of these CV models can then be used to automatically suggest annotations for future models, as well as, enable users to connect with any information associated with annotations of recognizable objects which is what that process 800 uses for a visual search for the real world. Additionally, a Natural Language Process (NLP) context detection model can use the identified associations with annotated 3D objects and their associated data (e.g. digital documents, digital photos, digital videos, sensor data, etc.) to surface additional contextually relevant connections.

More specifically, in one embodiment, n step 802 process 800 can obtain digital photograph(s) and/or other sensor input. In step 804, process 800 can implement various preprocessing protocols on said input. Example, input can include, inter alia, lidar 806 as well. In step 808, process 800 can implement photogrammetry on the input. Based on the output of step 808, process 800 can, in step 810, generate a point cloud of specified portions of the input content.

In step 812, process 800 can obtain CAD drawings of the object as well as other sensor inputs (e.g. visual information, measurements, LIDAR, etc.). In step 814, the CAD drawings can be used to generate a CAD model.

In step 816, process 800 can generate a textured mesh model of the point cloud and CAD model. In step 818, a user can provide manual annotations of the textured mesh model to generate an annotated model 820. The annotated model 820 can include various relevant documents 822 (e.g. manuals, maintenance data, etc.). In step 824, process 800 can enable various manual inputs such as, inter alia: manual document association, manual annotation association textured mesh to generate a manual annotation, auto document association textured mesh 826. A textured mesh can be a 3D model that is viewable in a virtual space. Users can add annotations/labels on the textured mesh. Documents can be associated to the textured mesh via the annotations/labels. It is noted that process 800 can implement NLP 828 on the documents 822. For example, the documents can be run through an optical character recognition process. An ontological layer can be built that helps to identify a relevant context for future uploaded documents. It can also be determined how a document is relevant to the object as a whole and/or specified subsystems of the object. This can be used to implement an auto-annotation process(es).

In step 820, process 800 can implement an annotation centric simulation 830 to generate simulated training data 832 using annotated/labeled textured mesh. A trained convolutional neural network 834 can operate on the simulated training data 832. This can be an automated simulation and test-set creation process. This can be implemented on an object-wide basis with lighting and other environmental effects to generate a corpus of data for training and test set data. It is noted that other embodiments, other types of trained CV models can be used in lieu of the trained convolutional neural network 834.

In step 836, process 800 can obtain new site digital photographs (e.g. from new customers/existing customers from new field sites, etc.). These new site digital photographs can be for new or similar objects to the one used in the previous steps. In step 838, process 800 can implement various photogrammetry and computer vision algorithms on the output of step 836. In step 840, process 800 can implement component recognition on the output of step 838. This can be used to generate/integrated with auto annotated, manual document associated textured mesh 844. It can also be annotated for auto annotation and/or auto document association textured mesh in step 842. Annotations can be used to focus 2D image generation for a different set of training data. Process 800 can also generate a physical asset difference analysis report in step 846. This can involve determine a difference in an object as a function of time. Various actions can then be suggested based on this difference as well. Process 800 can suggest annotations as well.

In one example, process 800 can obtain digital photographs of an object. The digital photographs can be converted to a 3D model of the object. The 3D can be placed in a virtual environment. A virtual camera can be provided in the virtual environment. The virtual camera can generate a set of 2D images from the 3D model. The virtual camera can obtain 2D images of the 3D model at different angles. The virtual camera can obtain 2D images of different sections of the model. An example section can be a component or subsystem of the object identified by a manual annotation. Various specified lighting effects and/or other environmental effects can also be applied via the virtual camera in the virtual environment. The set of 2D images can be used to train computer vision models. The training can be to recognize new aspects of the objects with computer vision in the field.

Process 800 can be used to train multiple computer vision modules. Using these trained computer vision modules, process 800 can analyze new images as a textured mesh is trained. Process 800 can also be used to surface content related to a digital image obtained with a user's mobile device in the field. Process 800 can create associate points between a physical object and a set of information assets (e.g. documents, videos, etc.) of the object. Information assets can be related to a component of the object as well. For example, a digital image of a component of an oil rig can be obtained with a mobile device application. Process 800 can then surface the relevant operations manual and/or other related data about the oil-rig component in the mobile device application.

It is noted that, in some examples, the system provides the core of the analysis engine that enables an automated site monitoring system. The automated site monitoring system is a drone-based site monitoring system. The site of the site monitoring system is an industrial site where the industrial site is a petroleum production, transportation or storage site.

Conclusion

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A computerized method useful for associating relevant information with a point of interest on a virtual representation of a physical object created using digital input data comprising:
receiving at least one sensor input of a physical object;
using the at least one set of sensor inputs to create a virtual representation of the physical object;
determining at least one point of interest on the physical object;
obtaining at least one point of relevant informational input data; and
associating the at least one point of relevant informational input data with at least one point of interest on the physical object.

2. The computerized method of claim 1,
wherein the sensor comprises a digital photograph or a LIDAR input, and
wherein the informational input association is automatically implemented.

3. The computerized method of claim 2,
wherein the virtual representation of a physical object comprises a point cloud, and
wherein the virtual representation comprises a textured mesh.

4. The computerized method of claim 3,
wherein the creation of the virtual representation is done using photogrammetry
wherein a creation of the virtual representation is enhanced through the use of a library of geometric primitives.

5. The computerized method of claim 4,
wherein the association of informational input data is implemented with an annotation
wherein the annotated virtual representation is stored as a part of a collection of a plurality of annotated virtual representations,
wherein the physical object is identified through the application of a CV algorithm,
wherein the CV algorithm's training dataset is created through simulation using at least one other virtual representation in the collection,
wherein the at least one point of interest is identified through the application of a CV algorithm,
wherein the CV algorithm's training dataset is created through simulation using the at least one other virtual representation in the collection,
wherein the at least one point of interest is determined through the application of an NLP algorithm, and
wherein the NLP algorithm's training dataset is all existing informational input data in the collection.

6. A computerized method comprising the steps of:
obtaining a sensor input of an object;
generating a point cloud representation of the object with the sensor input;
generating a textured mesh representation of the objects with point cloud representation and the sensor input;
providing the textured mesh representation in a virtual environment;
annotating the textured mesh representation to create an annotated textured mesh representation;
generating a set of two dimensional (2D) images of the annotated textured mesh representation;
providing the set of 2D images as an input as a training data for a computer-vision system; and
with the computer vision system:
training the computer vision system with the set of 2D images to generating a computer-vision model, wherein the computer-vision model recognizes a later generated textured meshes as another object of a same class as the object.

7. The computerized method of claim 6, wherein the sensor input comprises a digital photograph of the object.

8. The computerized method of claim 7, wherein the sensor input comprises a CAD input.

9. The computerized method of claim 8, wherein the sensor input comprises a LIDAR input.

10. The computerized method of claim 9, wherein the annotation is obtained from a digital document related to the object, another digital photograph of the object, a digital video of the object, another sensor data of the object.

11. The computerized method of claim 10, wherein the 2D images are obtained from a set of specified positions of a virtual camera.

12. The computerized method of claim 11, wherein the 2D images are obtained from a set of specified virtual lighting and environmental conditions simulated in the virtual environment.

13. The computerized method of claim 12, wherein the textured mesh representation comprising a three-dimensional representation in the virtual environment.

14. The computerized method of claim 13, wherein the computer vision system recognizes a whole objects, a sub-system of the other object or an individual component of the other object.

15. The computerized method of claim 14 further comprising:
training the computer vision system with the set of 2D images to recognize a difference between the object and a later state of the object;
wherein the computer vision system recognizes a difference between the object and the later state of the object.

16. The computerized method of claim 8 further comprising:
using the computer-vision model to automatically suggest annotations for another computer-vision models.

17. The computerized method of claim 11 further comprising:
enabling a user to obtain information associated with an annotation from any object recognized using the computer-vision model.

18. The computerized method of claim 17 further comprising:
providing a Natural Language Process (NLP) context detection model; and
with the NLP context detection model, identifying an association with annotated three-dimensional object and a set of associated data to surface additional contextually relevant connections.

19. A computerized system useful for associating relevant information with a point of interest on a virtual representation of a physical object created using digital input data, comprising:
at least one processor configured to execute instructions;
a memory containing instructions when executed on the processor, causes the at least one processor to perform operations that:
receive at least one sensor input of a physical object;
use the at least one set of sensor inputs to create a virtual representation of the physical object;
determine at least one point of interest on the physical object;
obtain at least one point of relevant informational input data; and
associate the at least one point of relevant informational input data with at least one point of interest on the physical object.

20. The computerized system of claim 19,
wherein the sensor comprises a digital photograph or a LIDAR input, and
wherein the informational input association is automatically implemented.
